(19) United States
(12) Patent Application Publication
(10) Pub. No.: US 2010/0039549 A1
(43) Pub. Date: Feb. 18, 2010

(54) COMMUNICATION TERMINAL

(75) Inventor: YUNG-YU KAO, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: Chi Mei Communication Systems, Inc., Tu-Cheng City (TW)

(21) Appl. No.: 12/339,334

(22) Filed: Dec. 19, 2008

(30) Foreign Application Priority Data
Aug. 13, 2008 (CN) 200810303743.0

(51) Int. Cl. H04N 5/225; G02B 7/02

(52) U.S. Cl. 348/335; 359/813; 348/E05.024

(57) ABSTRACT

An exemplary communication terminal includes a housing, a camera module, and a zooming subassembly. The housing defines a guiding slot. The camera module is positioned in the housing. The zooming subassembly includes a convex lens and a controlling member. The controlling member is connected to the convex lens and slidably received in the guiding slot. The convex lens is capable of moving in front of the camera module when the controlling member moves along the guiding slot.

### BACKGROUND

1. Technical Field

The present disclosure relates generally to communication terminals and, more particularly, to a communication terminal having a camera module.

2. Description of the Related Art

A communication terminal, such as a mobile phone, generally has a camera module, convenient for a user to capture an image of an object. The camera module of the mobile phone usually occupies a small volume and has a fixed focus. Therefore, an aperture of the camera module is small, and a depth of field of the camera module is high. When using the camera module of the mobile phone to capture an image of a distant object, a quality of the photo improves with a high depth of field, even though the camera module may have a fixed focus. However, when using the lens module of the mobile phone to capture an image of a close object, the quality of the photo decreases due to the high depth of field and the fixed focus of the camera module.

Therefore, a communication terminal to solve the aforementioned problems is desired.

### SUMMARY

An exemplary communication terminal includes a housing, a camera module, and a zooming subassembly. The housing defines a guiding slot. The camera module is positioned in the housing. The zooming subassembly includes a convex lens and a controlling member. The controlling member is connected to the convex lens and slidably received in the guiding slot. The convex lens is capable of moving in front of the camera module when the controlling member moves along the guiding slot.

Other advantages and novel features will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present communication terminal. Moreover, in the drawings, like reference numerals designate corresponding parts throughout the several views.

FIG. 1 is an isometric view of a first embodiment of a communication terminal, the communication terminal including a housing, a camera module, and a zooming subassembly.

FIG. 2 is a cross-sectional view of the camera module of the communication terminal in FIG. 1, taken along line II-II.

FIG. 3 is a front view of the communication terminal in FIG. 1, when capturing an image of a distant object.

FIG. 4 is a schematic optical path view of the communication terminal in FIG. 3.

FIG. 5 is a front view of the communication terminal in FIG. 1, when capturing an image of a close object.

FIG. 6 is a schematic optical path view of the communication terminal in FIG. 5.

FIG. 7 is a front view of a second embodiment of a communication terminal, when capturing an image of a close object.

FIG. 8 is a front view of the communication terminal in FIG. 7, when capturing an image of a distant object.

FIG. 9 is a front view of a third embodiment of a communication terminal, when capturing an image of a close object.

FIG. 10 is a front view of the communication terminal in FIG. 9, when capturing an image of a distant object.

FIG. 11 is a front view of a fourth embodiment of a communication terminal, when capturing an image of a close object.

FIG. 12 is a front view of the communication terminal in FIG. 11, when capturing an image of a distant object.

### DETAILED DESCRIPTION OF THE EMBODIMENTS

References will now be made to the drawings to describe the embodiments in detail.

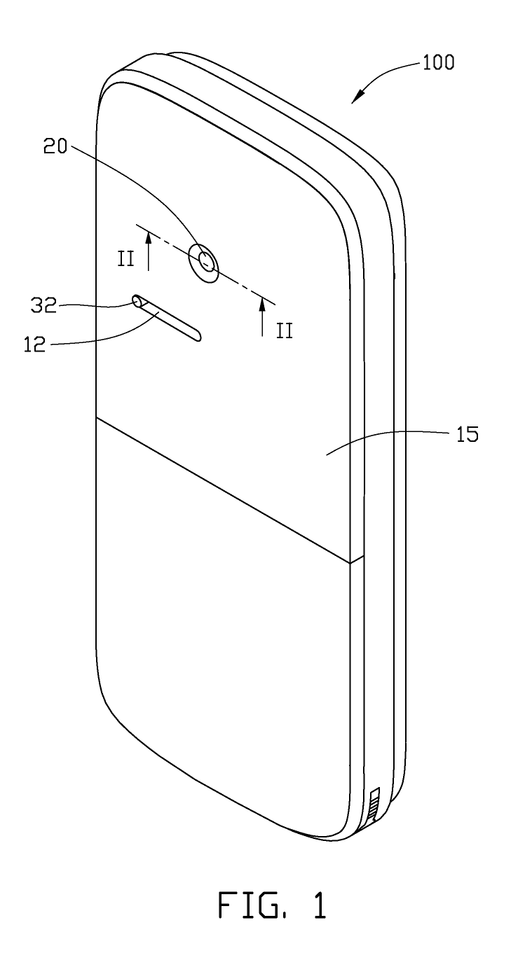

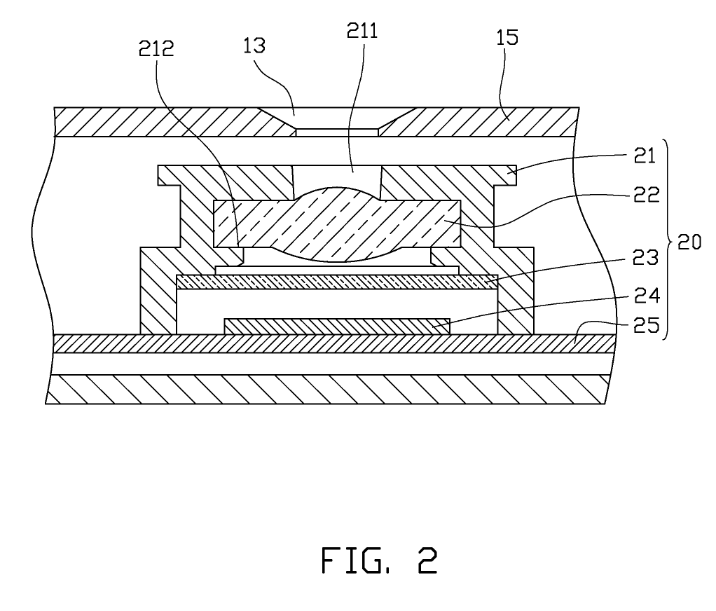

Referring to FIGS. 1 through 3, a first embodiment of a communication terminal 100 includes a housing 15, a camera module 20, and a zooming subassembly 30. The camera module 20 and the zooming subassembly 30 are positioned in the housing 15.

The housing 15 defines an elongated guiding slot 12 and a through hole 13 corresponding to the camera module 20. The guiding slot 12 is adjacent to the through hole 13.

The camera module 20 includes a lens holder 21, a lens group 22, an infrared filter 23, an optical sensor 24, and a printed circuit board 25.

The lens holder 21 defines a through hole 211. The lens group 22, the infrared filter 23, and the optical sensor 24 are received in the lens holder 21. The through hole 211 of the lens holder 21 and the through hole 13 of the housing 15 are aligned in a straight line. An assembling portion 212 is formed on the inner surface of the lens holder 21, configured for holding the lens group 22. The lens group 22 includes one or more lenses. The infrared filter 23 is positioned below the lens group 22. The printed circuit board 25 is positioned on a bottom of the lens holder 21. The optical sensor 24 is electrically positioned on the printed circuit board 25. The optical sensor 24 may be a charge coupled device (CCD).

The zooming subassembly 30 includes a convex lens 31, a controlling member 32, and a connecting pole 33. The convex lens 31 is movably positioned between the camera module 20 and the through hole 13 of the housing 15. The controlling member 32 is slidably received in the guiding slot 12, and protrudes out of the housing 15 via the guiding slot 12. One end of the connecting pole 33 is fixed to the controlling member 32 and the other end of the connecting pole 33 is fixedly connected to the convex lens 31. An extending direction of the guiding slot 12 of the housing 15 is substantially perpendicular to an extending direction of the connecting pole 33. The convex lens 31 moves in the housing 15 when the controlling member 32 slides along the guiding slot 12.

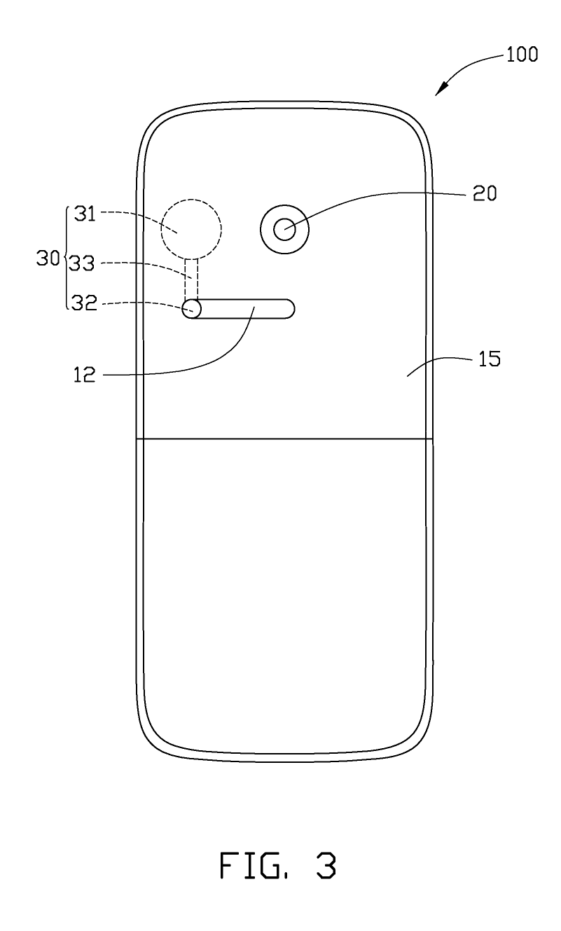

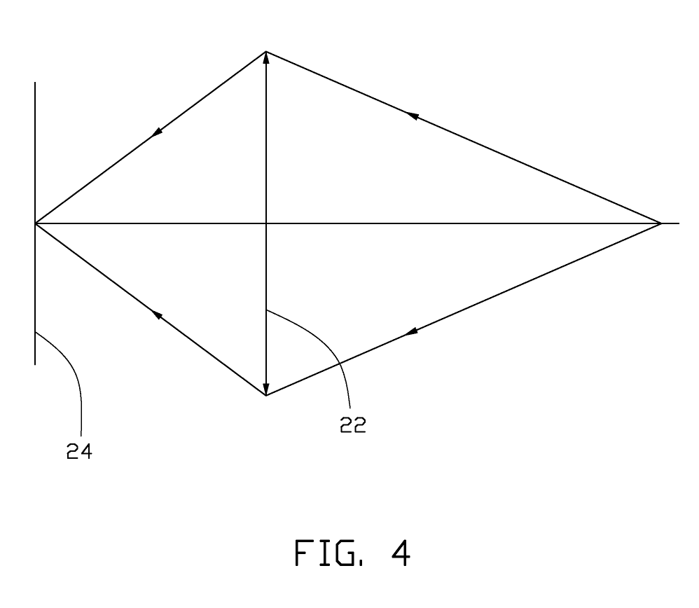

Referring to FIGS. 3 and 4, when the camera module 20 is used to capture an image of a distant object, the controlling member 32 and the convex lens 31 is positioned away from the line of sight of the optical sensor 24, for example, at a left end of the guiding slot 12. The light directly enters the camera module 20, and is focused on a center of the optical sensor 24 accurately via the lens group 22. The optical sensor 24 receives an optical signal accurately, and changes the optical signal to an electrical signal. A user can then see a picture with high quality on a display of the communication terminal 100.

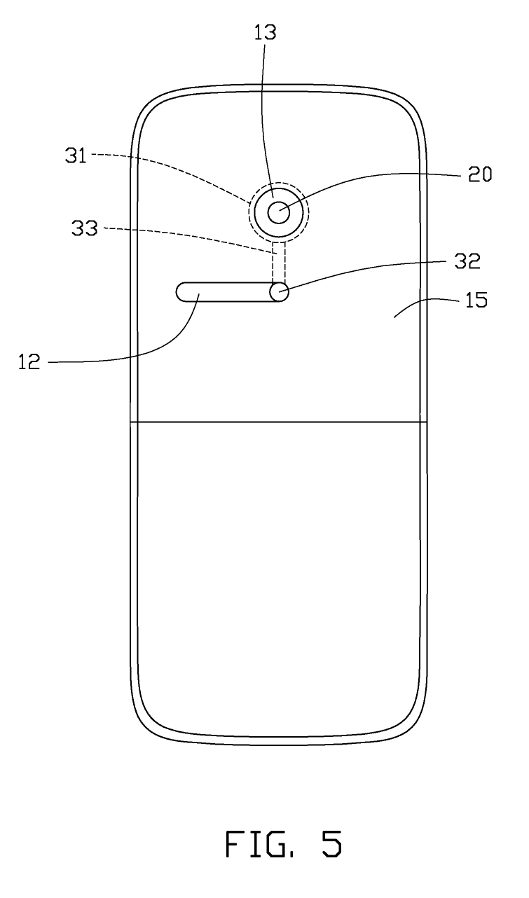

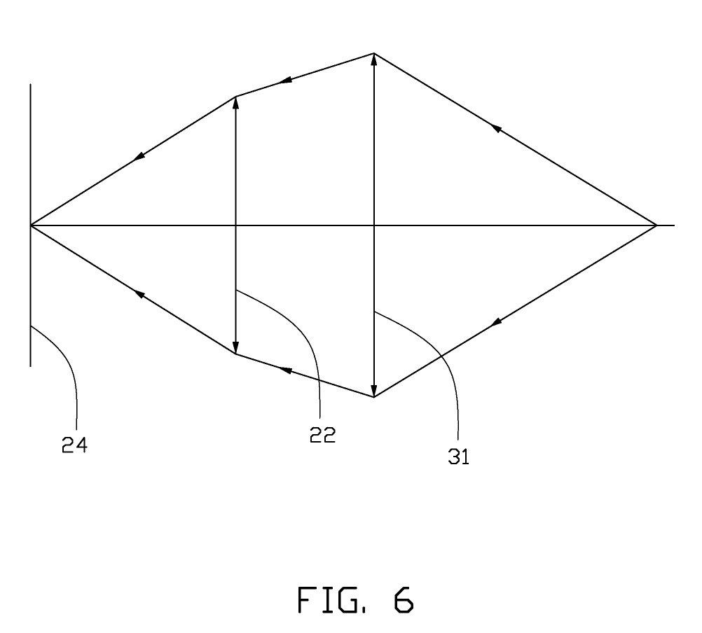

Referring to FIGS. 5 and 6, when the camera module 20 is used to capture an image of a close object, the controlling member 32 is positioned in front of the line of sight of the optical sensor 24, for example, at a right end of the guiding slot 12. The light becomes focused by the convex lens 31 before entering the camera module 20, so the light rays are also focused on the center of the optical sensor 24 accurately by the lens group 22. The optical sensor 24 receives an optical signal accurately, and changes the optical signal to an electrical signal. Thus, a user can see a picture with high quality on a display of the communication terminal 100.

It should be pointed out that, the controlling member 32 may be elastic, thus increasing a friction force between the controlling member 32 and the housing 15. Therefore, the controlling member 32 slides stably relative to the housing 15. In addition, the zooming subassembly 30 may not include the connecting pole 33. For example, the controlling member 32 may be directly connected to the convex lens 31, and a positioning protrusion may be formed at an edge of the convex lens 31. Then, the housing 15 defines a sliding slot, and the positioning protrusion of the convex lens 31 is slidably received in the sliding slot.

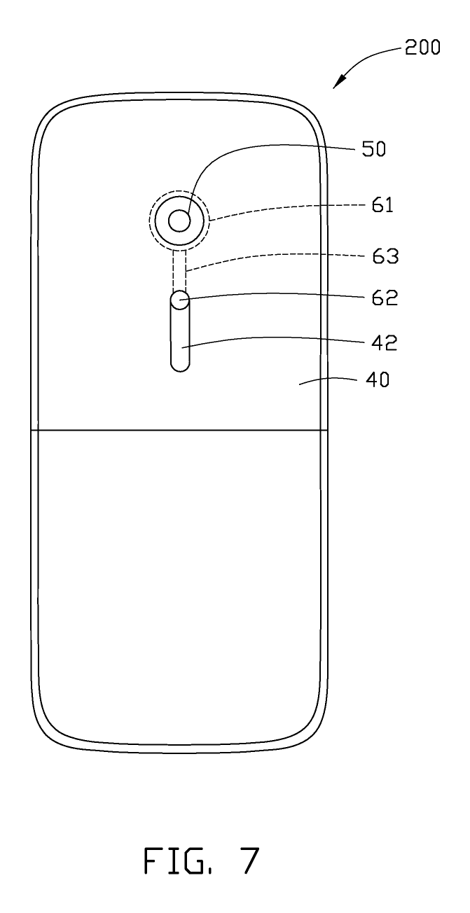

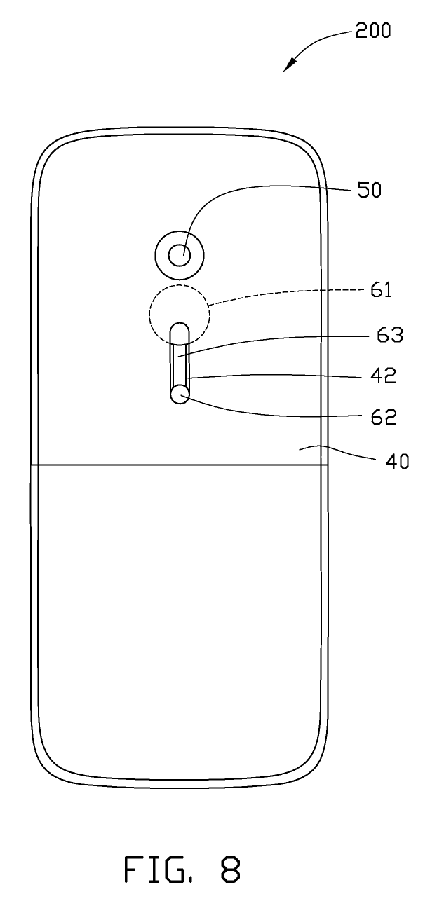

Referring to FIGS. 7 and 8, a second embodiment of a communication terminal 200 is similar to the first embodiment of the communication terminal 100, except that an extending direction of a guiding slot 42 of a housing 40 is substantially aligned with an extending direction of the connecting pole 63. When a controlling member 62 is positioned at a top end of the guiding slot 42, a convex lens 61 is positioned in front of the camera module 50. When a controlling member 62 is positioned at a bottom end of the guiding slot 42, the convex lens 61 is positioned at a bottom side of the camera module 50. Therefore, the communication terminal 200 can also capture an image of the distant object and the close object with high quality via adjusting the controlling member 62.

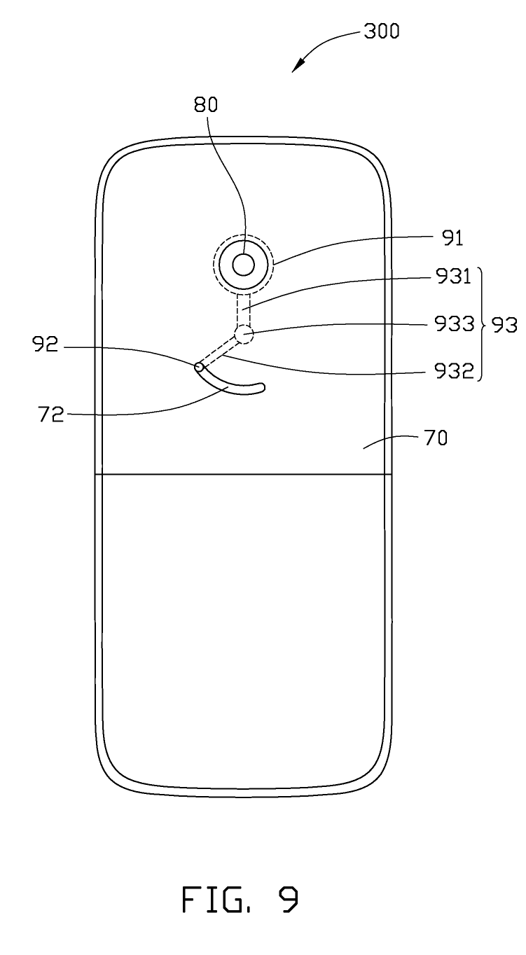

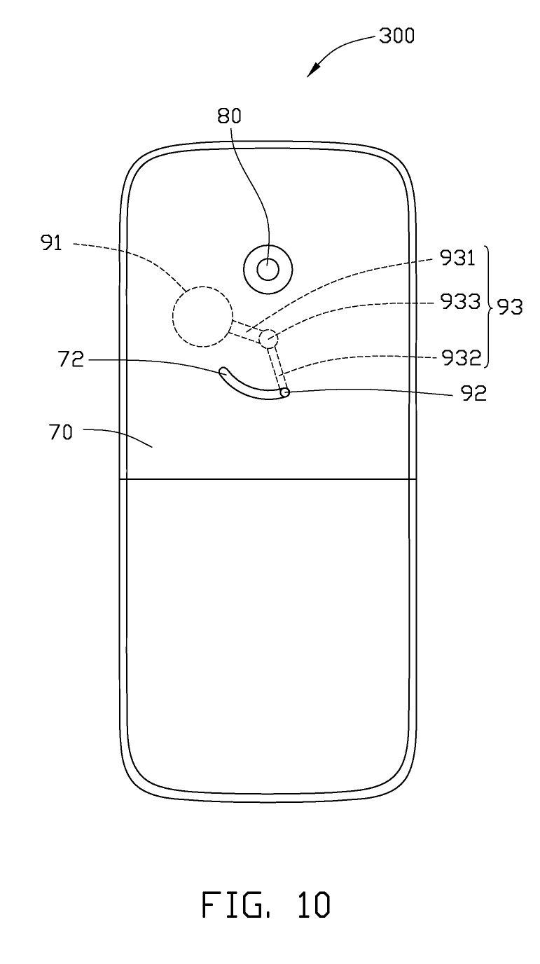

Referring to FIGS. 9 and 10, a third embodiment of a communication terminal 300 is similar to the first embodiment of the communication terminal 100, except that the convex lens 91 is connected to the controlling member 92 by a connecting member 93. The connecting member 93 includes a first arm 931, a second arm 932, and a rotatable shaft 933. The first arm 931 is connected to a convex lens 91, and the second arm 931 is connected to a controlling member 92. The first arm 931 and the second arm 932 are non-rotatably connected on the rotatable shaft 933, and form a fixed angle. The rotatable shaft 933 is rotatably connected to a housing 70. A guiding slot 72 of the housing 70 is a curved slot. When the controlling member 92 slides along the guiding slot 72, the first arm 931 and the second arm 932 rotate relative to the rotating shaft 93. For example, when the controlling member 92 is positioned at a left end of the guiding slot 72, the convex lens 61 is positioned in front of the camera module 80, and when the controlling member 62 is positioned at a right end of the guiding slot 42, the convex lens 61 is positioned at a side of the camera module 80. Therefore, the communication terminal 300 can capture an image of the distant object and the close object with high quality via adjusting the controlling member 62.

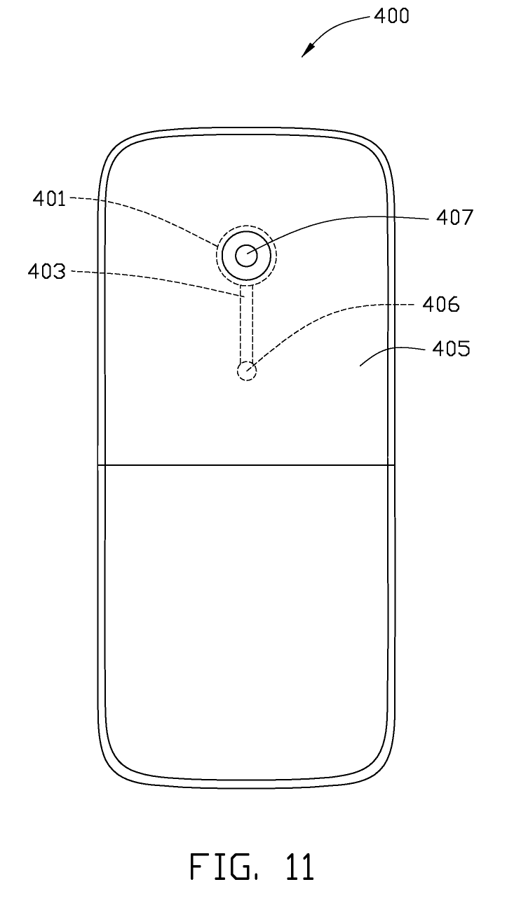

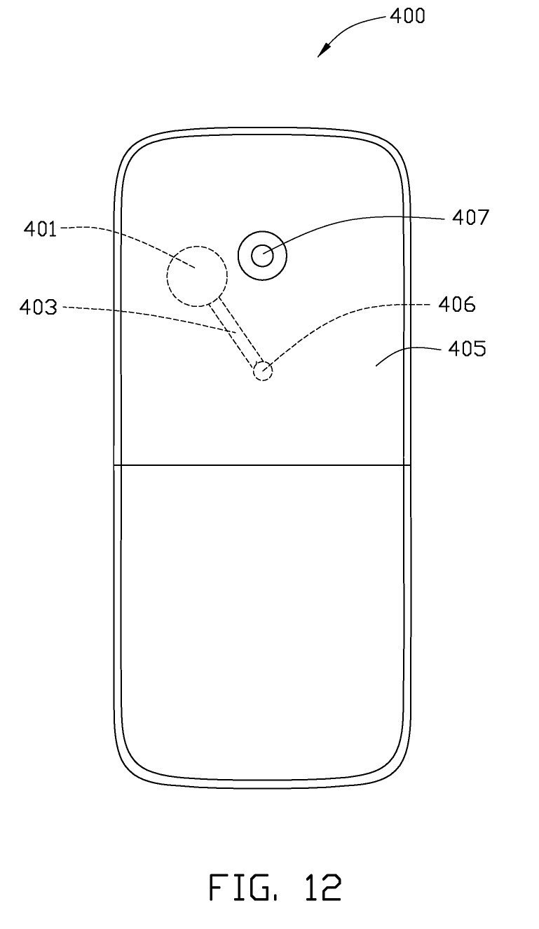

Referring to FIGS. 11 and 12, a fourth embodiment of a communication terminal 400 is similar to the first embodiment of the communication terminal 100, except that a convex lens 401 is connected to a connecting pole 403. The connecting pole 403 is rotatably connected to a housing 405 via a rotating shaft 406. The convex lens 401 can be positioned on in front of a camera module 407 or a side of the camera module 407 via rotating the connecting pole 403. Therefore, the communication terminal 400 is also capable of capturing an image of the distant object and the close object with high quality via rotating the connecting pole 403.

It is believed that the present embodiments and their advantages will be understood from the foregoing description, and it will be apparent that various changes may be made thereto without departing from the spirit and scope of the or sacrificing all of its material advantages, the examples hereinbefore described merely being preferred or exemplary embodiments of the invention.

What is claimed is:

1. A communication terminal, comprising:
a housing defining a guiding slot;
a camera module positioned in the housing;
a zooming subassembly having:
a convex lens, and
a controlling member connected to the convex lens and slidably received in the guiding slot, and protruding out of the housing via the guiding slot, wherein the convex lens is capable of moving in front of the camera module when the controlling member moves along the guiding slot.

2. The communication terminal as claimed in claim 1, further comprising a connecting member connecting the convex lens to the controlling member.

3. The communication terminal as claimed in claim 2, wherein the connecting member is a connecting pole; the convex lens and the controlling member are fixed to opposite ends of the connecting pole.

4. The communication terminal as claimed in claim 3, wherein the guiding slot is an elongated slot.

5. The communication terminal as claimed in claim 4, wherein an extending direction of a guiding slot of the housing is substantially aligned with an extending direction of the connecting pole.

6. The communication terminal as claimed in claim 4, an extending direction of a guiding slot of the housing is substantially perpendicular to an extending direction of the connecting pole.

7. The communication terminal as claimed in claim 1, wherein the connecting member comprises a first arm, a second arm, and a rotating shaft; the first arm is connected to the convex lens, and the second arm is connected to the controlling member; the first arm and the second arm are connected by the rotating shaft; the guiding slot is an arched slot; the controlling member is slidably received in the guiding slot.

8. The communication terminal as claimed in claim 1, wherein the controlling member is elastic.

9. The communication terminal as claimed in claim 1, wherein the camera module comprises a lens holder, a lens group, and an optical sensor; the lens group and the optical sensor are received in the lens holder.

10. The communication terminal as claimed in claim 1, wherein the housing defines a through hole capable of receiving light rays from outside, and corresponding to the camera module.

11. A communication terminal, comprising:
a housing;
a camera module positioned in the housing;
a zooming subassembly, wherein the zooming subassembly has a convex lens movably connected to the housing, and capable of moving in front of the camera module.

12. The communication terminal as claimed in claim 11, further comprising a controlling member connecting the convex lens, and movably positioned on the housing.

13. The communication terminal as claimed in claim 11, further comprising a connecting member connecting the convex lens to the controlling member.

14. The communication terminal as claimed in claim 13, wherein the connecting member is a connecting pole; the convex lens and the controlling member are fixed to opposite ends of the connecting pole.

15. The communication terminal as claimed in claim 11, wherein the camera module comprises a lens holder, a lens group, and an optical sensor; the lens group and the optical sensor are received in the lens holder.

16. The communication terminal as claimed in claim 11, wherein the housing defines a through hole capable of receiving light rays from outside, and corresponding to the camera module.
